(19) United States
(12) Patent Application Publication
(10) Pub. No.: US 2014/0346329 A1
(43) Pub. Date: Nov. 27, 2014

(54) PHOTOACOUSTIC TRANSDUCER WITH OPTICAL FEEDBACK

(71) Applicant: FUJIFILM Sonosite, Inc., Bothell, WA (US)

(72) Inventors: Desmond Hirson, Thornhill (CA); Nicholas Christopher Chaggares, Oshawa (CA); James Mehi, Thornhill (CA); Danny Gurevich, Thornhill (CA)

(73) Assignee: FUJIFILM Sonosite, Inc., Bothell, WA (US)

(21) Appl. No.: 14/286,930

(22) Filed: May 23, 2014

Related U.S. Application Data
(60) Provisional application No. 61/827,520, filed on May 24, 2013.

(51) Int. Cl. G01S 15/89

(52) U.S. Cl. CPC G01S 15/8965
USPC 250/227.11

(57) ABSTRACT

A photoacoustic ultrasound transducer receives excitation light on a bundle of optical fibers. The optical fibers in the bundle are divided to direct the excitation light onto light bars positioned on either side of an imaging stack. A small portion of the optical fibers direct a portion of the excitation light onto an optical sensor that is located within the transducer housing.

### CROSS-REFERENCES TO RELATED APPLICATIONS

This application claims benefit of and priority to U.S. Provisional Patent Application Ser. No. 61/827,520, filed on May 24, 2013, and entitled “PHOTOACOUSTIC TRANSDUCER WITH OPTICAL FEEDBACK,” which is hereby incorporated herein in its entirety by reference.

### TECHNICAL FIELD

The disclosed technology relates to photoacoustic imaging systems and to photoacoustic transducers in particular.

### BACKGROUND

Photoacoustic sensing and imaging is a mechanism where properties of tissue can be examined based on the response of the tissue to excitation light pulses. As will be understood by those skilled in the art, short pulses of laser excitation light that are directed onto tissue cause the tissue to rapidly heat and expand. This rapid expansion creates an ultrasonic signal that can be detected, analyzed and converted into an image. Because different types of tissue will heat and expand differently when exposed to the excitation light pulses, the ultrasound signals produced have different signal characteristic and images can be produced where the different types of tissue can be seen.

While the theory of photoacoustic imaging system is well understood, there are significant hurdles associated with being able to produce good images with the technology. One factor that can produce variations in the ultrasound signals received is the variations in the power of the excitation light pulses produced the light source. It is not uncommon for variations in the pulses to vary by more than +/−5% for a well tuned laser system and by +/−10% for less regulated excitation light systems. The variations in laser light power are directly proportional to the strength of the ultrasound signals created. Therefore, in order to compensate the images produced for the variations in the laser light power used to produce the ultrasound signals, it is desirable to know how much light was applied to the tissue.

Prior solutions such as those described in PCT/US2011/034640 measure the power of light reflected from the tissue in order to gauge how much light power was applied to the tissue. While this approach can work, improvements can be made. Given this problem, there is a need for an improved system that can measure the light energy that is applied to tissue in a photoacoustic imaging system.

### SUMMARY

As will be discussed in further detail below, the disclosed technology relates to photoacoustic imaging systems and in particular to photoacoustic imaging transducers that can measure the power of laser light that is delivered to a region of interest. In one embodiment, a transducer receives laser excitation light on a bundle of optical fibers. The fibers are randomized to produce a uniform light distribution. One portion of the fibers is coupled to a light bar that runs along one side of an acoustic stack that includes an ultrasound transducer. Another portion of the fibers is coupled to a second light bar that runs along the other side of the acoustic stack. A small percentage of the fibers in the bundle are coupled to an optical sensor that is located in a transducer handle.

In one embodiment, the optical sensor is a Pyro-Electric crystal based sensor that is positioned proximal to the acoustic stack in the transducer handle. The optical fibers are coupled to the sensor with an SMA optical coupler. Signals from the optical sensor are digitized and analyzed by a programmed processor to adjust the gain of images produced in response to ultrasound signals detected by the transducer. In one embodiment, the optical fibers coupled to the optical sensor are arranged in the transducer handle such that they have the same length as the optical fibers that are coupled to the light bars.

### BRIEF DESCRIPTION OF THE DRAWINGS

FIG. 1 is a cut away view of a photoacoustic transducer with an integral optical sensor constructed in accordance with one embodiment of the disclosed technology; and

FIG. 2 is a block diagram of a photoacoustic imaging system constructed in accordance with an embodiment of the disclosed technology.

### DETAILED DESCRIPTION

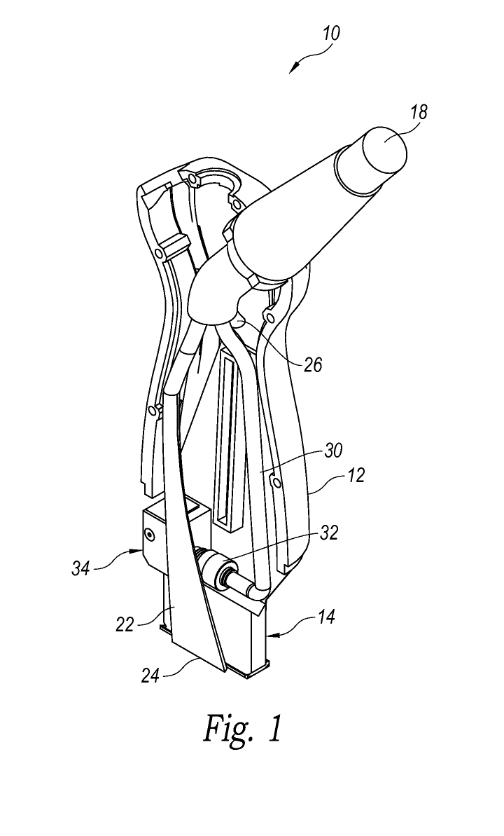

One embodiment of the disclosed technology is illustrated in FIG. 1. A photoacoustic (also sometimes referred to as optoacoustic) transducer 10 includes an ergonomic handle 12 that is shaped to be held by a user. The transducer 10 includes an acoustic stack 14 that comprises an array of ultrasound elements that are configured to transmit and receive ultrasound energy. Such elements may comprise piezoelectric elements, CMUT devices or the like. Signal leads (not shown) transfer electronic signals produced by the transducer elements to a remote ultrasound imaging system (also not shown). The acoustic stack 14 also includes a lens and one or more matching layers for the ultrasound elements.

A bundle of optical fibers 18 delivers optical excitation light to the transducer 10. The optical fibers in the bundle are preferably randomized so that the supplied optical energy at one end bundle will be uniformly distributed without any hot spots at the other end of the bundle. Within the transducer 10, the bundle of fibers 18 is split into three or more groups. A first group of fibers 22 is optically coupled at a distal end to a laser light bar 24 or other lens system that is located along one edge of the front face of the acoustic stack 14. A second group of fibers 26 is optically coupled at a distal end to a laser light bar (not shown) or other lens system that is located along a second edge of the front face of the acoustic stack 14. In one embodiment, the light bars on either side of the acoustic stack 14 focus the light in the fibers within a region of interest from which the ultrasound transducer elements in the acoustic stack 14 receive ultrasound signals.

In accordance with one embodiment of the disclosed technology, a small percentage (e.g. 3-5%) of the optical fibers in the bundle 18 is split into a third bundle 30 that is coupled at a distal end to a light sensor 34. The optical fibers in the bundle 30 preferably have the same length as those optical fibers that are coupled to the light bars on either side of the acoustic stack. To keep the length of the fibers in the bundle 30 the same as those fibers that are coupled to the light bars, there may need to be some bending or routing of the bundle optical fibers in the transducer housing. In one embodiment, the optical fibers in the bundle 30 are coupled to the light sensor 34 with an SMA optical connector. The optical sensor 34 produces signals that are reflective of the power of the optical signals that are delivered to the tissue (or other object to which the transducer is engaged). As discussed above, the power of the light pulses may vary due to variations in the laser power. In addition, the power may vary due to the effect of filters such as an optical parameter oscillator that are place in the light path.

As can be seen in FIG. 1, the optical sensor 34 is located behind (i.e. proximal of) the acoustic stack 14 and is contained within the body of the ultrasound transducer 10. Light impinging the optical sensor is therefore not dependent on collecting light that is reflected from the tissue. In addition, the optical sensor is not subject to being obscured during use. In another embodiment, the optical sensor 34 may be located partially within the body of the transducer 10. Alternatively, the optical sensor 34 may be external to the body of the tranducer 10. In any embodiment, the optical sensor is positional to receive light on a portion of the optical fibers in the bundle 18.

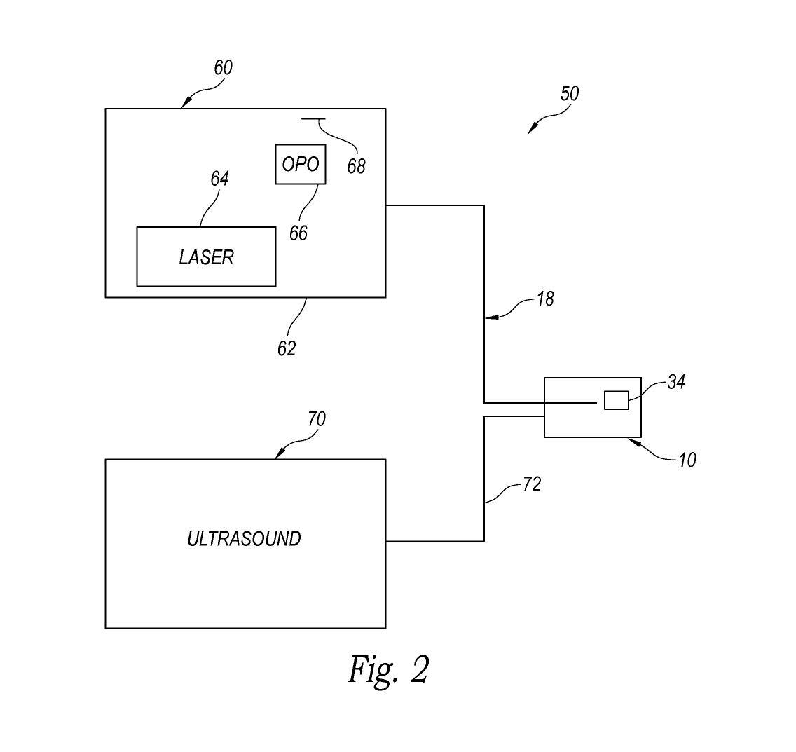

FIG. 2 is a block diagram of a photoacoustic imaging system constructed in accordance with one embodiment of the disclosed technology. The imaging system 50 includes a light source 60 that is within a light-tight housing 62. A high power laser 64 provides the optical excitation light and an optical parametric oscillator 66 is included in the light path to change the wavelength of the laser light if desired. A current sensor 68 is provided in the light source 60 to monitor the laser pulses energy at the OPO output. This energy reading is used to correct for image intensity fluctuations due to changes in pulse to pulse light energy as well as changes in energy for the different wavelengths.

Light from the laser 64 is delivered to the transducer 10 through the bundle of optical fibers 18. Signals from the ultrasound transducer are carried from the transducer 10 to an ultrasound imaging system 70 on a number of wires or other signal carriers 72.

As discussed above, the ultrasound system preferably includes a programmed processor that operates to receive the ultrasound signals produced by the transducer as well as the signals produced by the optical sensor 34. The optical sensor 34 produces signals that are proportional to the strength or power of the light pulses that exit the optical fibers within the transducer. Depending on the strength of the light pulses, the gain of the ultrasound signals may be increased or decreased during the creation of images from the ultrasound signals.

From the foregoing, it will be appreciated that specific embodiments of the invention have been described herein for purposes of illustration, but that various modifications may be made without deviating from the scope of the invention. In another embodiment, the optical sensor 34 need not be completely contained within the transducer housing but may be only partially contained within the transducer housing.

Accordingly, the invention is not limited except as by the appended claims.

I/we claim:

1. A transducer for a photoacoustic imaging system, comprising:
a housing;
a ultrasound transducer that is configured to receive echo signals from a region of interest;
a fiber optic bundle configured to receive excitation light from a remote light source, wherein optical fibers in the bundle are arranged to direct a portion of the excitation light into the region of interest; and
an optical sensor that is located within the housing and is configured to receive a portion of the excitation light via one or more optical fibers from the bundle of optical fibers.

2. A transducer for a photoacoustic imaging system, comprising:
a housing;
a ultrasound transducer in the housing that is configured to receive echo signals from a region of interest in response to one or more pulses of excitation light;
a fiber optic bundle configured to receive excitation light from a remote light source, wherein optical fibers in the bundle are split to direct a portion of the excitation light into the region of interest from opposite sides of the ultrasound transducer; and
an optical sensor that is configured to receive a portion of the excitation light via one or more optical fibers from the bundle of optical fibers.

3. A transducer for a photoacoustic imaging system, comprising:
a housing;
an ultrasound transducer in the housing that is configured to receive echo signals from a region of interest in response to one or more pulses of excitation light;
a fiber optic bundle configured to receive excitation light from a remote light source, wherein optical fibers in the bundle are split to direct a portion of the excitation light into the region of interest from opposite sides of the ultrasound transducer; and
an optical sensor that is located proximal to the ultrasound transducer and is completely contained within the housing to receive a portion of the excitation light via one or more optical fibers from the bundle of optical fibers.

4. The transducer of claim 2, wherein the optical sensor is located within the housing.

5. The tranducer of claim 2, wherein the optical fibers that provide light to the optical sensor have the same length as the optical fibers that provide light to the region of interest.
